(19) United States
(12) Patent Application Publication
(10) Pub. No.: US 2020/0139304 A1
(43) Pub. Date: May 7, 2020

(54) TRANSITIONAL METAL OXIDE NANOCRYSTAL-COATED MESOPOROUS MICROSTRUCTURES, USES THEREFOR, AND PROCESSES FOR MAKING SAME

(71) Applicant: University New Brunswick, Fredericton (CA)

(72) Inventors: Gobinda Saha, Fredericton (CA); Balaji SUBRAMANIAN, Kingston (CA); Brian MACLEAN, Fredericton (CA); Ogbogu Kalu, Fredericton (CA)

(21) Appl. No.: 16/444,939

(22) Filed: Jun. 18, 2019

Related U.S. Application Data
(60) Provisional application No. 62/686,468, filed on Jun. 18, 2018.

(51) Int. Cl. B01D 67/00; B01D 61/02; B01D 69/10; B01D 71/02; C02F 1/44

(52) U.S. Cl. CPC B01D 67/0076; B01D 67/0048; B01D 61/027; C02F 2101/20; B01D 71/027; B01D 71/028; C02F 1/442; B01D 69/105

(57) ABSTRACT

Transitional metal oxide-coated mesoporous microstructures, uses therefor, and processes for making same are provided. The transitional metal oxide-coated mesoporous microstructures can be silica based, including MCM-41, MCM-45, MCM-48, SBA-15 and SBA-16. The microstructures can include microspheres. The mesoporous microstructures can be produced using a sol-gel process wherein the crystallization step in the sol-gel process is carried out at a low temperature, where the temperature can be 22° C. for example. The metal oxide can be titanium dioxide. The titanium dioxide can include titanium dioxide nanocrystals. The transitional metal oxide-coated mesoporous microstructures can be used in environmental applications, such as nanofiltration of contaminated water to remove pollutants.

### FIELD

The present invention relates to the field of mesoporous microstructures, their uses and processes for making same.

### BACKGROUND

The world is facing daunting challenges in meeting rising demands for clean water in the face of population growth, climate change, and increasing industrialization. Currently, about one billion people in the world lack access to clean water. It has been estimated that over the next two decades the average supply of water per person is likely to drop by a third, potentially leading to millions of preventable deaths. The World Economic Forum (2015) has described the water crisis as the number one global risk based on societal impact, as water has a broad impact on health, food, energy, and economies. Therefore, the question is: how to maximize the usability of clean water through the purification of contaminated water or waste water.

While water scientists and engineers have employed various methods of water purification, the viability of current practices such as the nanofiltration of contaminated water through porous materials have been questioned, given i) stricter legislation on water quality requirements, and ii) high costs involved in the chemical synthesis, physical operation and installation of the facilities used. As such, it is important to establish a water purification process that is reliable, but also cost effective, and sustainable.

### SUMMARY

In one implementation, the present disclosure relates to a process for producing a transitional metal oxide-coated mesoporous material, including dispersing a mesoporous material in a solvent to form a mesoporous material dispersion, adding a transition metal oxide solution to the dispersion to form a mixture, and collecting the resulting transitional metal oxide coated mesoporous material. In another implementation, the mesoporous material includes microspheres. In another implementation, the transitional metal oxide is TiO₂. In another implementation, the transition metal oxide solution includes transitional metal oxide nanocrystals. In another implementation, the mesoporous material is silica based. In another implementation, the TiO₂ includes TiO₂ nanocrystals. In another implementation, the TiO₂ is prepared from Ti(iPO)₄ as the TiO₂ source material. In another implementation, the mesoporous material has been produced using a sol-gel process wherein self-assembly of silica-pluronic molecules leading to molecular periodic arrangement in the sol-gel process is carried out at a low temperature. In another implementation, the low temperature is about 22° C. In another implementation, the low temperature is between about 1° C. and about 30° C. In another implementation, the low temperature is room temperature. In another implementation, the mesoporous material is selected from the group consisting of MCM-41, MCM-45, MCM-48, SBA-15 and SBA-16. In another implementation, the titanium dioxide nanocrystals are made from Ti(iPO)₄ as the titanium dioxide source material.

In one implementation, the present disclosure relates to a transitional metal oxide-coated mesoporous material produced according to processes of the present disclosure.

In one implementation, the present disclosure relates to a metal oxide-coated mesoporous material including mesoporous silica coated with titanium dioxide nanocrystals. In another implementation, the present disclosure relates to a metal oxide-coated mesoporous material, wherein the mesoporous silica include microspheres. In another implementation, the mesoporous silica include hexagonal particles. In other implementations, other particle shapes are possible. In another implementation, the present disclosure relates to a metal oxide-coated mesoporous material wherein the mesoporous silica is SBA-16.

In one implementation, the present disclosure relates to use of a metal oxide-coated mesoporous material of the present disclosure for nanofiltration.

In one implementation, the present disclosure relates to a titanium dioxide doped SBA-16-type silica microsphere for the adsorption and photocatalytic degradation of hazardous organic compounds (for example: organic dyes like crystal violet) in water.

In another implementation, the present disclosure relates to ordered mesoporous silica structures (such as SBA-16) with titanium dioxide for the development of a sustainable, cost-effective, novel, multi mechanism alternative water purification methodology. SBA-16 type mesoporous-microspheres are synthesized by a sol-gel method with Pluronic F127 employed as a structure directing agent (template) and TEOS (tetraethyl orthosilicate) as a silica source. Surface modification of these SBA-16 type microspheres through titanium dioxide nanocrystals results in titanium dioxide doped SBA-16 silica composite microspheres. Several characterization techniques were used to analyze the microspheres. SEM and TEM results show the size range, sphericity and ordered nature of the microspheres, while EDX analysis shows the presence of titanium atoms evidencing a titanium dioxide layer. The characterization of the composite microspheres and their application in photocatalytic degradation tests confirm the viability of SBA-16 silica composite microspheres for the adsorption and photocatalytic degradation of hazardous organic compounds in polluted waters.

In another implementation, the present disclosure relates to the synthesis of SBA-16-type mesoporous-microspheres by a sol-gel method with Pluronic F127 employed as a structure directing agent (template) and TEOS (tetraethyl orthosilicate) as a silica source, with surface modification of the SBA-16-type silica microsphere through titanium dioxide nanocrystals, whereby a titanium dioxide doped SBA-16-type silica microsphere is produced.

In one implementation, the present disclosure relates to an ordered mesoporous silica structures (for example, MCM-41, MCM-45, MCM-48, and SBA-15) with controlled pore sizes ranging from 2 to 50 nm with titanium dioxide for improved nanofiltration of contaminated water to remove pollutants. Pollutants can include, for example, dissolved heavy metals, harmful organic waste, micro-organic pollutants such as endocrine disrupters, antioxidants, plasticizers, fire retardants, insect repellents, solvents, insecticides, herbicides, fragrances, food additives, prescription drugs, non-prescription drugs (like caffeine, nicotine, stimulants, etc.) and pharmaceuticals (like birth control, antibiotics, etc.).

In another implementation, the present disclosure relates to a multifunctional material including an ordered mesoporous silica structure with titanium dioxide, usable for water purification through contaminant molecule attraction (adsorption); and highly reactive, photo-generated, hydroxyl radical facilitated destructive oxidation. The material has high adsorption capabilities and the ability to be regenerated/recycled so that the nanofiltration process is sustainable.

In another implementation, the present disclosure relates to a process for producing a multifunctional material using an advanced sol-gel process, providing a facile low-cost route to highly structured materials and hybrid nanocomposite materials with organic and/or inorganic components.

In another implementation, the present disclosure relates to a titanium dioxide doped nanoporous silicate synthesized using a low temperature sol-gel method. In one aspect, the nanoporous silicate is an SBA-16-type.

In one implementation, the present disclosure relates to using a sol-gel process to produce a titanium doped SBA-16 type mesoporous material including the steps of surfactant templating, surfactant/inorganic interaction, surfactant template removal, and titanium dioxide doping.

In another implementation, the present disclosure relates to the synthesis of a titanium dioxide doped SBA-16 type mesoporous microsphere including pore sizes ranging from 2 to 50 nm, pollutant adsorption properties, and the ability to degrade adsorbed organic molecules by photocatalysis.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIGS. 1(a)-(d) are SEM images of phase I samples;

FIGS. 2(a)-(c) are types of TEM image results;

FIGS. 3(a)-(d) are TEM images of phase I samples;

FIGS. 4(a)-(d) are FFT images of phase I samples;

FIGS. 5(a)-(b) are SEM images of phase II samples;

FIG. 6 is a backscattered image of phase II samples;

FIG. 7 is an EDS Spectra of phase II samples;

FIGS. 8(a)-(b) are TEM images of phase II samples;

FIGS. 9(a)-(b) are FFT images of phase II samples;

FIGS. 10(a)-(b) are TEM images showing the secondary coating/film on phase II samples;

FIGS. 11(a)-(c) are SEM images of phase III samples;

FIG. 12(a)-(c) are TEM images of particle amorphization with beam exposure;

FIGS. 13(a)-(b) are TEM image of a phase III sample's particle (a) and one of its heavily concentrated titanium dioxide doping areas (b);

FIGS. 14(a)-(b) are black and white color representations of the SBA-16 titanium dioxide particle of interest obtained by EDS mapping;

FIGS. 15(a)-(c) are HK porosity distribution plots of a) SBA-16 sample, b) 30 mL titanium dioxide doped sample, and c) 45 mL titanium dioxide doped sample;

FIG. 16 is a Raman spectra of titanium dioxide doped phase III samples;

FIG. 17 is a graph of UV-Vis spectral changes of crystal violet in aqueous solution as it degrades with time;

FIG. 18 is a graph of UV-Vis spectral changes of crystal violet in aqueous solution as it degrades with time under the action of 30 mL TiO₂ doped SBA-16; and FIG. 19 is a graph of UV-Vis spectral changes of crystal violet in aqueous solution as it degrades with time under the action of 45 mL TiO₂ doped SBA-16.

### DETAILED DESCRIPTION

### Abbreviations

BET Brunauer-Emmett-Teller
BJH Barret-Joyner-Halenda
CMC Critical Micelle Concentration
CMT Critical Micelle Temperature
CPP Critical Packing Parameter
EDX Energy dispersive X-ray
FFT Fast Fourier transform
FTIR Fourier-transform infrared spectroscopy
HK Horvath-Kawazoe
IUPAC International Union of Pure and Applied Chemistry
MCM-x Mobil Composition of Matter number x
PEO Poly(ethylene oxide)
Pluronic F127 (ethylene oxide)106-(propylene oxide)70-(ethylene oxide)106
PPO Poly(propylene oxide)
SBA-x Santa Barbara Amorphous number x
SEM Scanning electron microscopy
TEM Transmission electron microscopy
TEOS Tetraethyl orthosilicate
TMOS Tetramethyl orthosilicate

Surfactant Templating

Being an uncontrolled reaction technique, the sol-gel process applied on its own produces disordered or poorly ordered structures with broad pore sizes and molecular weight distributions. This is the basis for incorporating a structure directing agent (surfactant template) during the process, as this incorporation creates a pathway to ordered porous material (like well-defined and structured SBA-16 material) and results in what some refer to as the advanced sol-gel process. Therefore, titanium dioxide doped SBA-16 advanced sol-gel synthesis begins with the creation of a surfactant template. Templating has been defined as a process in which an organic species functions as a central structure about which oxide moieties organize into a crystalline lattice. Meaning, templates are structures, usually organic, around which a material, often inorganic, nucleates and grows in a skin-tight manner, so that upon the removal of the templating structure, the inorganic materials replicate its geometric and electronic characteristics.

Surfactants (surface-active agents), are organic amphiphilic molecules. Meaning they are molecules with both hydrophilic (water-loving) and hydrophobic (water-repelling) regions. When dissolved in a solvent at low concentration, surfactants can adsorb at interfaces (that is liquid/liquid, solid/liquid, and gas/liquid boundaries) thereby altering significantly the physical properties of those interfaces. The transition of surfactant molecules into micelles (an aggregate (or supramolecular assembly) of surfactant molecules dispersed in a liquid colloid) that facilitate surfactant templating, occurs via cooperative assembly.

Micelles form only when the concentration of the surfactant is greater than the critical micelle concentration (CMC), and the temperature of the system is greater than the critical micelle temperature (Krafft temperature). At low concentrations, the surfactants energetically exist as monomolecules and with increasing concentration, surfactant molecules combine to form micelles to decrease the system entropy.

A surfactant's hydrophilic head may be anionic, cationic, nonionic or zwitterionic, while its hydrophobic tail may be hydrogenated or fluorinated, linear, or branched. In one embodiment, nonionic surfactant heads used as these surfactants (specifically triblock copolymers) have the ability to template ordered siliceous mesoporous materials (like SBA-16) and other inorganic phases. Mesoporous silicas formed using these nonionic block copolymers are more stable than those obtained in syntheses mediated by cationic surfactants as unlike the M41S materials formed by cationic surfactants, the SBA materials formed by nonionic block copolymer surfactants tend to have thicker silica walls. The type of surfactant used also affects pore size as block copolymers promote significantly larger pore sizes.

Of these block copolymers, certain triblock copolymers of the Pluronic family have been found to obtain ordered mesostructured silicas when applied as templates in mesoporous silica synthesis. Pluronic materials are a type of nonionic surfactant that take on the same EO-PO-EO general structure but can be differentiated through their molecular weight. Above the critical micelle concentration, short chain pluronics like L121 organize into well-defined lamellar mesostructured silica, middle chain pluronics like Pluronic P123 organize into well-defined two-dimensional hexagonal phase of rod-like micelles (SBA-15), while long chain pluronics like Pluronic F127 organize into a well-defined cubic phase of spherical micelles (SBA-16) as well as a bicontinuous cubic phase. Pluronic F127 is a nonionic triblock copolymer, meaning pluronic F127 is a polymer composed of three blocks of homopolymers in a linear sequence as shown below:

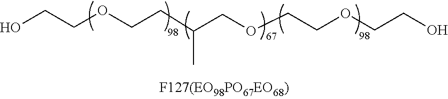

As a block copolymer consisting of poly (propylene oxide) (PO) and poly (ethylene oxide) (EO), pluronic F127 displays amphiphilic properties in aqueous solutions. Its PO homopolymers phase separate from water at relatively low temperatures (approximately 5° C.), whereas its EO homopolymers (that is, PEG, poly (ethylene glycol)) are well soluble in water. As it consists of a central PO block (hydrophobic) surrounded by two EO blocks (hydrophilic) its individual molecules associate in aqueous solutions forming micelles consisting of a PO core isolated from the surrounding solvent and a corona of hydrated EO segments in contact with surrounding solvent.

By varying the molecular weight and the EO/PO ratio, the amphiphilic character of the polymer can be modified. The amphiphilic behavior of (EO)ₓ-(PO)_{y}-(EO)ₓ polymers is also temperature dependent as raising the temperature makes the EU blocks become less soluble in water and as a result more hydrophobic.

Surfactant/Inorganic Interaction

Surfactant/inorganic interaction can be looked at as how the surfactant head group (S) binds with the inorganic precursor (I). This stage of the advanced sol-gel process utilizes monomeric alkoxide precursors. In solution, the alkoxides evolve sequentially through continuous overlapping hydrolysis and condensation reactions (and the reverse reactions, esterification and alcoholic or hydrolytic depolymerization) to form polymeric species composed of Metal-Oxide-Metal bonds. For an SBA-16 mesoporous silica case, this involves the binding of the silicate to the micelle surface during silicate polymerization as shown below:

The hydrolysis and condensation reactions begin with partial hydrolysis. That is the creation of reactive groups in the alkoxide by diluting the alkoxide in a solvent. This solvent is generally the alcohol of the alkoxy group. Meaning, in the case of the alkoxide tetraethylorthosilicate (TEOS), the best choice is ethanol. Reactive groups are important as they are necessary to enable condensation reactions which in turn form an oxide cluster needed for further hydrolysis and condensation reactions. In principle the addition of water to the silicon alkoxide should generate Si—OH groups through hydrolysis reactions. In the hydrolysis step the hydroxyl groups (OH) replace, via nucleophilic attack on the silicon atom by the oxygen atom of a water molecule, the alkoxide species (OR); the process produces the release of an alcohol molecule and the formation of a metal hydroxide, M-OH:

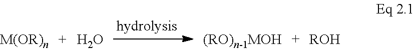

R represents the alkyl group, ROH the alcohol, and M the metal. Meaning in the case of tetraethylorthosilicate (TEOS) the hydrolysis reaction shown in Eq 2.1 becomes:

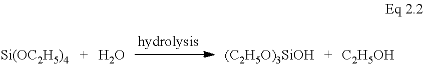

The reaction shown in Eq 2.1 can also go in the opposite direction in the form of an esterification reaction. That is alcohol can react with a hydrolyzed species to form a water molecule and an alkoxide ligand.

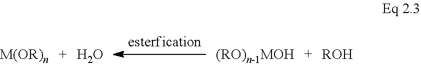

Once the first reactive OH groups are produced, the condensation reactions begin to take place. Condensation reactions form Si—O—Si units by releasing a water or an alcohol molecule. The reaction of two Si—OH groups give water as a by-product as shown in Eq 2.4 while the reaction of a Si—OH and Si—OR group gives an alcohol molecule as shown in Eq 2.5.

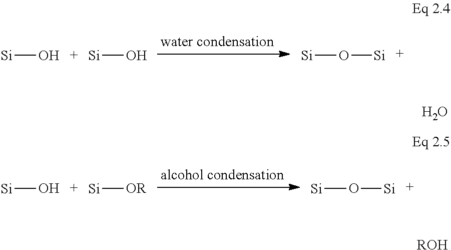

In the case of tetraethylorthosilicate (TEOS) the alcohol condensation equation shown in Eq 2.5 becomes:

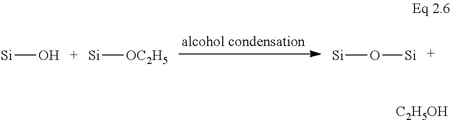

As the polycondensation reactions progress, an extended oxide network like that shown in below forms.

Surfactant Template Removal

Removal of the surfactant template from the as-synthesized inorganic organic composite is a very important step of the synthesis process as it is what results in the porosity of the material as depicted below:

Different removal methods influence the characteristics of SBA-16 mesoporous materials. The most common template removal method is calcination due to its easy operation and potential for complete surfactant elimination. As calcination involves heating the material to high temperatures in air or oxygen, meaning it allows for organic surfactants (like nonionic triblock copolymers) to be totally decomposed or oxidized under oxygen or air atmospheres; the drawbacks of calcination are the non-recovery of surfactants and the sacrifice of surface hydroxyl groups.

In 1999, Mobil scientists adopted a two-step calcination—the first 1 hour under nitrogen to decompose surfactants and the following 5 hours in air or oxygen to burn them out. In 2003, the procedure was simplified with the first calcination step under nitrogen substituted by low rate heating in air. Calcination temperature should be lower than the stable temperature of the mesoporous material (SBA-16) and higher than 350° C. to totally remove PEO-PPO-PEO type surfactants. It is very important that the temperature programming rate be low enough to prevent the structural collapse caused by local overheating. Heating the as-synthesized SBA-16 with a rate of 1-2° C./min to 550° C. and keeping this temperature for 4-6 hours can completely remove triblock copolymer templates. Higher calcination temperatures lead to lower surface areas, pore volumes, surface hydroxyl groups and higher cross-linking degrees of mesoporous materials.

Titanium Dioxide Doping

When it comes to titanium dioxide doping, literature suggests that sol-gel based functionalization of SBA-16 allows for this combination through co-condensation of a titanium dioxide source with a silica source or through post synthesis surface modification of the silanol group rich calcined SBA-16 silica surface. Notable examples of both approaches include W. Teng, Z. Wu, J. Fan, H. Chen, D. Feng, Y. Lv, J. Wang, A. M. Asiri and D. Zhao, Energy Environ. Sci., 2013, 6, 2765-2776, which is incorporated herein by reference, and which reports that a vinyl-functionalized analogous to SBA-16 can be synthesized by co-condensation of tetraethoxysilane (TEOS) and triethoxyvinylsilane (TEVS) in the presence of the triblock copolymer Pluronic P123 and inorganic salts such as NaCl; and Leisant et al.'s report (W.-J. Huang, B.-L. Cheng and Y.-L. Cheng, J. Hazard. Mater., 2007, 141, 115-122 which is incorporated herein by reference) of the synthesis of SBA-16 with mercaptopropyl groups by two routes: post synthesis grafting of pure mesoporous silica and direct functionalization by a co-condensation procedure.

Synthesis

A design of experiments was created to layout the framework of the experiments. As previously stated, in one embodiment, the process parameter being studied is the synthesis temperature. There are three base experiments, which are defined as E1 through E3. To ensure accuracy of results, it was decided that two, two, and three experiments would be performed for each of the base experiments respectively. Meaning, a total number of 7 experiments being conducted.

SBA-16 Titanium Oxide Treated Samples Preparation Procedure According to an Embodiment of the Present Invention

Place a clean, dry weighing paper on a balance and tare/zero the balance. Use a scoopula to transfer approximately 1.85 g of Pluronic F127 to the weighing paper on the balance and record the weight of the Pluronic F127 transferred, ensuring that all digits the balance displays are recorded.

Transfer the Pluronic F127 from the weighing paper to a clean dry 100 mL round bottom flask.

Using a 100 mL graduating cylinder, obtain, and add 50 mL of 0.2M hydrochloric acid to the 100 mL round bottom flask ensuring that the graduating cylinder is rinsed with 0.2M of hydrochloric acid before use.

Carefully set up a Fisher Isotemp Digital Hotplate in a fumehood.

Fill a large beaker (800 mL) with water, ensuring that the water level of the beaker is enough to adequately submerge about half of the 100 mL round bottom flask.

Place this beaker of water on the digital hotplate.

Ensure that the immersion probe of the digital hotplate is properly clamped and properly immersed in the water filled beaker.

Set the digital hotplate's temperature to 22° C. and its stirring speed to 350 rpm.

Submerge the 100 mL round bottom flask of Pluronic F127 and hydrochloric acid into the bath of water being heated by the digital hotplate, and put a clean dry hydrochloric acid rinsed stirrer into the 100 mL round bottom flask.

Clamp the hydrochloric acid and Pluronic F127 mixture adequately in the water bath ensuring the top of the beaker is covered with an aluminum foil or a top cover.

Wait for three hours.

Measure and add 4.28 g of TEOS (Tetraethyl orthosilicate) to the surfactant solution

Leave the mixture stirring at 22° C. for 20 more hours.

Take off the round bottom flask from the bath and put it on a cock holder to allow the mixture age at room temperature for 7 days.

Wash the solid product and collect the washed product by centrifugation.

Oven dry the product overnight at 125° C.

Remove the surfactant through calcination carried out in air by heating the resulting material from room temperature to 560° C. at increments of about 7 C/min, held at peak temperature (560° C.) for about 5 hours.

Using a graduated cylinder, add 15 mL of already made TiO₂ nanocrystal solution to an absolute ethanol and SBA-16 sample solution.

Take off the round bottom flask from the bath and put it on a cork ring to allow the mixture age at room temperature for 7 days.

Filter the mixture, wash solid the product by decantation with ethanol (3×), and collect the washed product by centrifugation.

Oven dry the product overnight at 125° C.

Remove the surfactant through calcination carried out in air by heating the resulting material from room temperature to 560° C. at increments of about 7 C/min, held at peak temperature (560° C.) for about 5 hours.

Equipment List: Weighing paper, balance (2 types), Pluronic F127, 100 mL round bottom flask, fisher Scientific Isotherm Digital Hotplate, bath/beaker big enough to hold a 100 mL round bottom flask, stirrer, 100 mL Graduating cylinder, syringe, parafilm, top cover, ethanol, HCl, clamp, fumehood, TEOS, cork ring, oven, centrifugation machine, decantation beakers.

SBA-16 Samples (Phase I)

SBA-16 samples were synthesized using a sol gel method with Pluronic F127 employed as a structure directing agent (template) and TEOS (tetraethyl orthosilicate) as a silica source. 1.85 g of the Pluronic F127 was dissolved in 50 mL of 0.2M HCl with vigorous stirring at specific controlled temperatures (22° C. and 30° C.). After approximately three hours, 4.28 g of TEOS was added to the surfactant solution with stirring at the mentioned temperatures (22° C. and 30° C.) for 20 more hours.

The mixture was aged at room temperature for 7 days, at which point the solid product was washed and collected by centrifugation, and oven dried overnight at 125° C. The surfactant was removed through calcination which was carried out in air by heating the resulting material from room temperature to 560° C. at increments of about 7° C./min, held at peak temperature (560° C.) for about 5 hours. The resulting samples where named SBA16-30 degC-1, SBA16-30 degC-2, SBA16-22 degC-3 and SBA16-22 degC-4.

Following this synthesis, an additional SBA-16 type sample was synthesized for the proof of concept tests. For this synthesis, 3.70 g of Pluronic F127 was dissolved in 0.2M HCl at 22° C. with stirring overnight. 8.56 g of TEOS was added with stirring at 22° C. for 20 hours, allowed to mature on benchtop for 1 week, filtered on paper, and washed with water. Collected material was filtered, washed with ethanol, dried in the oven at 100° C., and allowed to cool to room temperature; at which point 3.29 g of white solid was obtained. The white solid was ground with mortar and pestle, put into a crucible and calcinated in a furnace using the same calcination schedule as previous synthesis. After calcination, the sample was cooled and reweighed, at which point 2.10 g of the white solid was left. This sample was named SBA16-22 degC-POC.

SBA-16 Titanium Dioxide Doped Samples (Phase II)

Method 1

SBA-16 type titanium dioxide doped samples were synthesized using a sol gel method with Pluronic F127 employed as a structure directing agent (template), TEOS (tetraethyl orthosilicate) as a silica source and TTIP (titanium isopropoxide) as the TiO₂ (titanium dioxide) dopant. 1.85 g of the Pluronic F127 was dissolved in 15 mL of ethanol with constant stirring at 22° C., while about 0.56 mL of TTIP was dissolved separately in 10 mL of ethanol with constant stirring at room temperature. After approximately three hours, 4.28 g of TEOS was added to the solution (the Pluronic F127 flask). The TTIP solution was then added to the Pluronic F127 and TEOS mixture. The resulting mixture was stirred at 22° C. with an addition funnel dispensing drops of 25 mL of 0.2M HCl. Once all the HCl had been dispensed, the mixture was left stirring at 22° C. for 20 more hours. This method produced a mixture of titanium doped SBA-16 and titanium dioxide particles as the titanium dioxide immediately precipitated when HCl was added.

Method 2

SBA-16 titanium dioxide doped samples were synthesized using sol gel method with Pluronic F127 employed as a structure directing agent (template), TEOS (tetraethyl orthosilicate) as a silica source and titanium dioxide nanocrystals as the titanium dioxide dopant. TiO₂ (titanium dioxide) nanocrystals were made by stirring 16 mL of Ti(iPO)₄ under argon in a 22° C. bath; adding 6 mL of concentrated HCl dropwise to the Ti(iPO)₄ (produces smoking), allowing it to stir for 30 min. Then adding 80 mL of isopropanol, allowing it to stir overnight. The resulting titanium dioxide nanocrystal solution should be clear, pale yellow. 50 mg of the SBA-16 samples synthesized at 22° C. was dispersed in 15 mL of absolute ethanol with constant stirring at 22° C. 15 mL of already made titanium dioxide solution was then added to the absolute ethanol and SBA-16 sample solution. The mixture was then aged at room temperature for 7 days, at which point the solid product was filtered, washed by decantation with ethanol (3×), and oven dried overnight at 125° C. The surfactant was removed through calcination, which was carried out by heating the resulting material from room temperature to 560° C. at increments of about 7 C/min, held at peak temperature (560° C.) for about 5 hours. This method produced SBA-16 titanium dioxide doped samples. These samples where named SBA16-22 degC-TiO₂-1 and SBA16-22 degC-TiO₂-2.

Following this synthesis, three batches of SBA-16 titanium dioxide doped sample were synthesized for the proof of concept test using 15 mL, 30 mL and 45 mL of titanium dioxide nanocrystal solution on 50 mg of the SBA-16 sample (SBA16-22 degC-POC) synthesized for the proof of concept tests.

In all three cases, the solid interspersed well with the solution (didn't look like it needed further dilution with ethanol, so none was added). Each batch was stirred for 40 min under argon, then filtered on paper, dried in the oven at 100° C., cooled, collected and weighed. Of the 15 mL, 30 mL and 45 mL doped samples 0.36 g, 0.43 g, and 0.42 g respectively was left. These samples were then put into crucibles and heated at 450° C. in a furnace for an hour. They were named SBA16-22 degC-TiO₂—POC1, SBA16-22 degC-TiO₂—POC2, and SBA16-22 degC-TiO₂-POC3 respectively.

Morphological Characterization

Morphological characterization was carried out through scanning electron microscopy, transmission electron microscopy, nitrogen adsorption-desorption analysis and Raman spectroscopy analysis.

Scanning Electron Microscopy

Particle size and sphericity are critical to determine the accuracy of SBA-16 creations, meaning it is very important to have a visual representation of the SBA-16 material's particles. As scanning electron microscopes (SEMs) are designed to make sharp 3D micrographs of the surfaces of tiny objects to allow for the study of their surface morphologies (texture, shape, and size), scanning electron microscopy is an ideal method for getting this information. Scanning electron microscopy can be combined with energy dispersive X-ray microanalysis (EDX) to verify the composition of the material being studied. This becomes very important when establishing a connection between the titanium dioxide doping amount predicted (amount of doping used in the synthesis) and the titanium dioxide doping amount achieved.

SEM micrographs of the SBA-16 and titanium dioxide doped SBA-16 samples were obtained at UNB's Microscopy and Microanalysis Facility using a JEOL JSM 6400 scanning electron microscope. SEM samples were applied dry to carbon tape. SBA-16 TEM samples (phase I samples) were coated with a thin layer of gold to provide conductivity while titanium dioxide doped SBA-16 samples (phase II samples) were coated with a thin layer of carbon for EDS spectra purposes. EDS spectra were collected with an EDAX Genesis 4000 Energy Dispersive X-ray (EDS) analyzer. Images for both phases were collected with a Gatan Digital Micrograph using a digiscan interface. These images were analyzed using ImageJ to determine the approximate diameters of the particles occurring at the different temperatures.

Transmission Electron Microscopy

While SEM gives a 3D depiction of the sphericity and size of the particles, it is unable to give detailed information on the grain orientations in polycrystalline materials or pore structures in the mesoporous silica. TEM and FFT can be used to study the pore structure of the materials as TEM allows for the resolution of features in the range of 1 Å and FFT of the TEM micrographs gives the diffraction pattern of these features. TEM micrographs of the SBA-16 samples were obtained at DNB's Microscopy and Microanalysis Facility using a JEOL JEM 2011 transmission electron microscope with scanning option at an accelerating voltage of 200 kV. SBA-16 TEM samples (phase I samples) were prepared by dusting the dry sample directly on carbon film grids while titanium dioxide doped SBA-16 samples (phase II samples) were prepared by suspending the particles in ethanol, dispersing with an ultrasonic bath, and pipetting the solution onto a carbon film grid. Images for both phases were collected with a Gatan Ultrascan camera using a digital micrograph.

Nitrogen Adsorption-Desorption Analysis

While SEM and TEM analysis help visualize material structure, a big part of mesoporous material characterization is determining the material's specific surface area, pore volume and pore size distribution. Gas sorption allows for this determination. Using the Brunauer-Emmet-Teller (BET) method, accurate and detailed quantitative data of the pores can be determined. Nitrogen adsorption-desorption measurements were obtained at UNB's Microscopy and Microanalysis Facility using a BELSORP-max machine. About 0.15 g of the respective titanium dioxide doped SBA-16 sample was degassed at 200° C. for 10 hours before measurements were taken. The BET (Brunauer-Emmett-Teller) method and the HK (Horvath-Kawazoe) method were used in combination with the measurements taken to determine the pore size distribution and the surface area of the samples respectively. Total pore volume was calculated using the amount of absorbed Nitrogen gas (N₂) at a relative pressure (P/P₀).

Raman Spectroscopy

Raman spectroscopy studies indicate the nature of atoms in a material and as a result can be used to confirm compounds expected to be present, and their nature. For the case of the titanium dioxide doped SBA-16 material, while EDX might confirm the presence of titanium, silicon, and oxygen elements. It is important to establish that the doping really is titanium dioxide and not titanium or some other oxide of titanium and that the titanium dioxide doping is in the Anatase phase. Raman spectra were measured with Dilor LabRam-1B micro-Raman spectrum, using an excitation laser at 633 nm. The spectra were recorded at room temperature by the condition of 50 s integral time at a 1 cm⁻¹ resolution.

Proof of Concept Tests

The viability of the SBA-16 titanium dioxide doped samples for the adsorption and photocatalytic degradation of hazardous organic compounds in water, was investigated and quantified by monitoring the SBA-16 silica composite microsphere's adsorption and degradation of crystal violet. Fisher scientific (certified reagent 99%) crystal violet with an initial concentration of 20 mg/L in de-ionized water and resulting solution pH of 5.7 was used. UV irradiation of the crystal violet was carried out in a 100 mL capacity quartz container using a 32 cm (W)×33 cm (D)×21 cm (H) Luzchem irradiation chamber equipped with six top side, four left side and four right side UV-B lamps. In a typical procedure, 60 mL of crystal violet solution was mixed with 50 mg of SBA-16 titanium dioxide doped powder.

The adsorption of the dye molecules on the surface of the SBA-16 titanium dioxide doped samples (SBA16-22 degC-TiO₂—POC1, SBA16-22 degC-TiO₂—POC2, and SBA16-22 degC-TiO₂—POC3) was facilitated by stirring (use an ultrasonic agitator to help better disintegrate and dissolve components in the solution for 15 minutes after each hour of stirring) the crystal violet SBA-16 type titanium dioxide doped powder solution in the dark for 8 hours (overnight). Following stirring, 2 mL of the solution was collected periodically (at 2 minutes, 4 minutes, 10 minutes, 20 minutes, 30 minutes, 40 minutes, 60 minutes, and 90 minutes) from the quartz container during illumination.

The solutions were analyzed by Cary Series UV-Vis spectrophotometry in the wavelength range 190-1100 nm (Biochrome Ultraspec 2000) using a quartz cell. To verify the self-photolysis of crystal violet, a blank test was also carried out by irradiating the crystal violet solution without the SBA-16 silica composite. The degradation of crystal violet was ascertained from the follow up of the absorption peak at 591 nm.

Results and Discussion

Results collection and analysis consisted of three phases. Phase I focused on results from the proof of concept synthesis of SBA-16 at 22° C. and 30° C. The results provided data that allowed for a direct comparison between SBA-16 materials at the two temperatures to determine what temperature would be more advantageous for a water purification application. Phase II focused on gathering data to establish the effectiveness of the novel titanium dioxide doping procedure. The results of this phase proved that the titanium dioxide doping approach is effective through various qualitative and quantitative data obtained. As phase II result collection and analysis indicated that material composition criteria had been met, phase III (proof of concept tests) was implemented. Phase III data collection focused on applying the titanium dioxide doped SBA-16 samples to the adsorption and photodegradation of an organic compound (in this case crystal violet dye) in water. The results of the tests strongly support the implementation of the samples to water purification.

Characterization of SBA-16 Samples (Phase I)

Scanning Electron Micrograph (SEM) Analysis

FIG. 1 shows SEM images of all four SBA-16 samples prepared at this phase. Figure columns identify the preparation temperature while the rows indicate the magnification level. The 30° C. prepared samples (SBA16-30 degC-1 and SBA16-30 degC-2) are shown in the first two columns (FIGS. 1(a) and (b) respectively), while the 22° C. prepared samples (SBA16-22 degC-3 and SBA16-22 degC-4) are shown in the last two columns (FIGS. 1(c) and (d) respectively). Images were analyzed using ImageJ to determine the approximate diameters of the particles occurring at the different temperatures. The 30° C. samples show corresponding morphology with individual particle sizes of about 0.21 μm² and agglomerated particle sizes of about 1.01 μm². The 22° C. samples also show corresponding morphology, with individual particle sizes of about 19.26 μm².

FIG. 1 also shows that the 22° C. particles are significantly better separated than the 30° C. particles. As well separated particles are preferable for adsorption, synthesis at the 22° C. temperature was determined to be more advantageous for a water purification application. This is very convenient as this has the added benefit of cost savings in terms of energy expended, as it takes little if any heating or cooling (energy) to keep a synthesis happening at room temperature at 22° C.

Transmission Electron Micrograph (TEM) Analysis

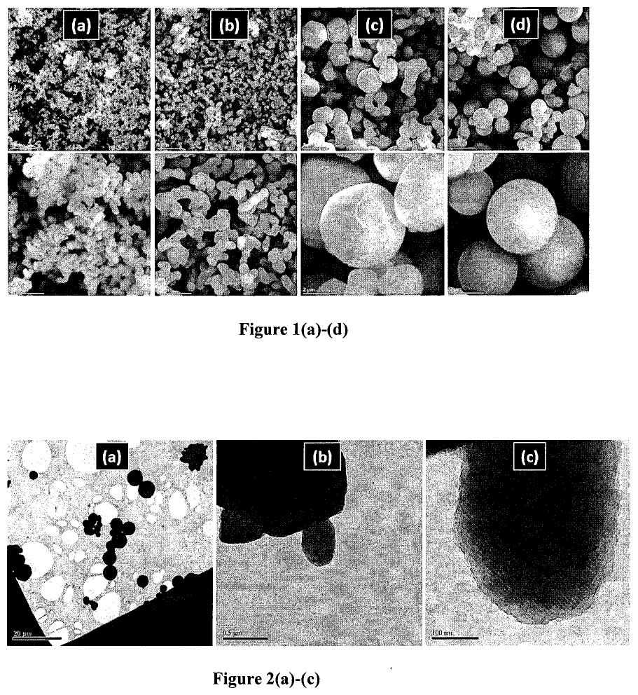

FIG. 2 shows the three types of TEM image results obtained. Low magnification FIG. 2(a) like images establish a relationship between TEM images and the 3D morphology observed in the SEM images, as they highlight 2D projection of spherical particles which are the TEM equivalent of the 3D spherical particles seen in the SEM images. While these types of low magnification images are ideal for establishing a correlation between SEM and TEM images they do not provide crystal lattice information. This is because the particles shown here are too big and hence too thick to be observed. Meaning that even at an accelerating voltage of 200 kV, the TEM machine's beam cannot get through these particles, so they show up as opaque. High magnification FIG. 2(b) like images provide crystal lattice information. While these types of images show particles that are not spherical, which might lead to some confusion as to whether the nature of the particles is spherical, the key is in the magnification.

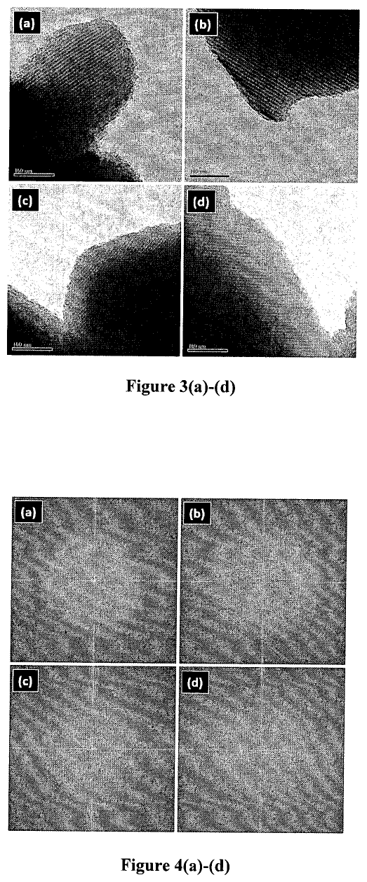

As FIG. 2(b) like images are taken at a significantly higher magnification, particles shown in these images are significantly smaller than those shown in FIG. 2(a) like images. The reason for this is that FIG. 2(b) like images show fragments of FIG. 2(a) like image particles that are significantly thinner than FIG. 2(a) like image particles and hence easier to observe in a TEM machine. Meaning significantly smaller fragments of the bigger FIG. 2(a) like particles which take on various shapes are looked for as they are significantly thinner and hence are more likely to show the lattice fringes needed to determine the nature of the crystal structure. FIG. 2(c) like images show what the lattice fringes look like. FIG. 2(c) like images have the greatest magnification of the three images and are the images used to determine the nature of the crystal structure. FIG. 3 shows lattice fringes for all four SBA-16 samples prepared at this phase while FIG. 4 shows their Fast Fourier Transforms. The 30° C. prepared samples (SBA16-30 degC-1 and SBA16-30 degC-2) are shown in the first row (FIGS. 3(a) and (b) respectively), while the 22° C. prepared samples (SBA16-22 degC-3 and SBA16-22 degC-4) are shown in the second row (FIGS. 3(c) and (d) respectively). Lattice fringes present in the FIG. 3 images suggest that the samples have an ordered porous structure. Regions without these fringes do not necessarily imply that the particle becomes more disordered, as increase in thickness of the particles result in less visible lattice structures. While the (110) crystal face is the only face detected for the 22° C. prepared samples, at the 30° C. synthesis temperature, the crystal faces of (100), (110), and (111) can be clearly detected, demonstrating that the SBA-16 material although relatively structured when synthesized at the low 22° C. temperature shows higher structural order degree at relatively high temperatures. ImageJ based TEM measurements further verify that the SBA-16 possesses cubic body-centered Im3m symmetry structure, which is in accordance with SEM characterization results.

Fast Fourier Transforms shown in FIG. 4 are suggestive of a

$$7.72 \frac{nm}{c ycle} , 8.64 \frac{nm}{cycle}$$

plane spacing for the 30° C. prepared samples and a

$$6.15 \frac{nm}{c ycle} , 7.98 \frac{nm}{cycle}$$

plane spacing 22° C. prepared samples respectively.

Characterization of SBA-16 Titanium Dioxide Doped Samples (Phase II)

In one embodiment of the present invention, titanium dioxide is present not simply as a mixture but as a coating on the SBA-16-type particles.

Scanning Electron Micrograph (SEM) Analysis

FIG. 5 shows SEM images of all titanium dioxide doped SBA-16 samples prepared at this phase. Figure rows indicate the magnification level. The first batch of titanium dioxide doped samples (SBA16-22 degC-TiO₂-1) is shown in the first column (FIG. 5(a)) while the second batch of titanium dioxide doped samples (SBA16-22 degC-TiO₂-2) is shown in the second column (FIG. 5(b)). The samples have corresponding morphology, showing individual spherical particles with fractured surfaces and sizes ranging from about 16.39 to about 46.28 μm².

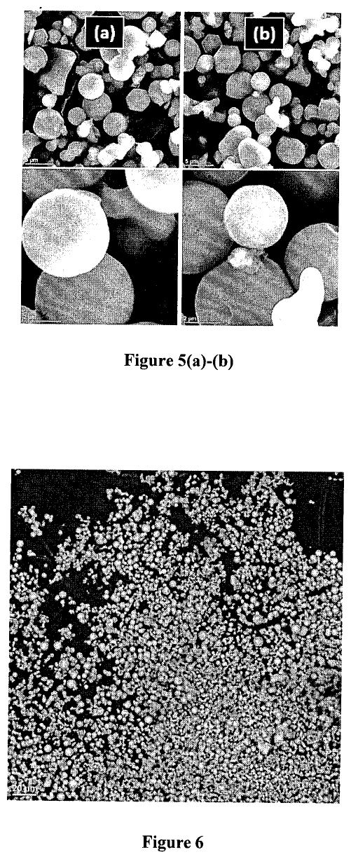

FIG. 6 shows the back scattered image of a titanium dioxide doped SBA-16 sample. The inventors find that all the particles show pretty much the same intensity, a good indication that the particles are homogenous in terms of material composition. Although the Back-scattered Electron Detector shows atomic contrast, it is influence by topography and since these samples are not flat and polished there is a gradient visible on the spherical edges. This does not necessarily indicate a change in atomic density around the corners, but instead a bit of topography, as backscatter also shows topography because the particles are round (not flat and polished).

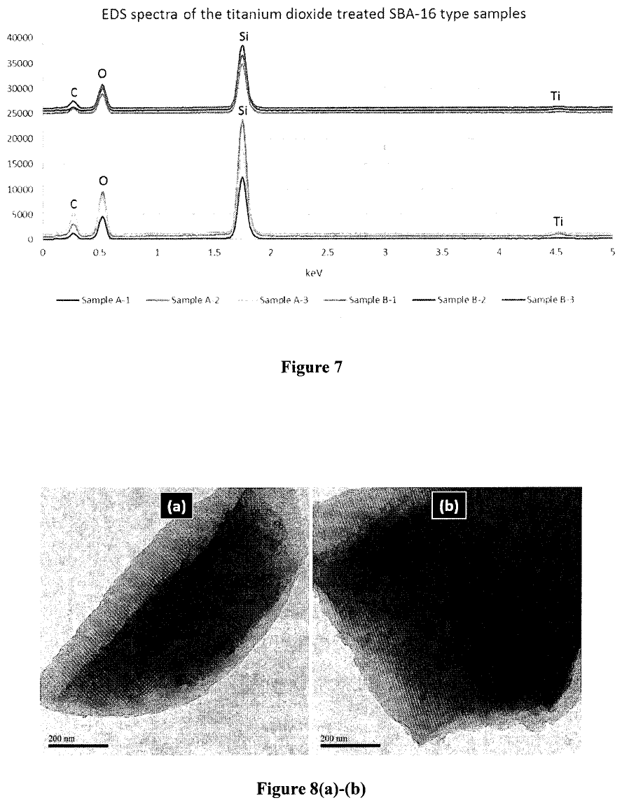

FIG. 7 shows EDS spectra with peaks at the characteristic energies for the elements present in the titanium dioxide doped SBA-16 samples. As both the titanium dioxide doped SBA-16 samples and the EDS standards are carbon coated for EDS analysis, there are no numbers for carbon weight percent even though they are visible on the graphs. The tabulated results in Table 1 provide a quantitative view of the elemental composition in the various inspection fields in units of weight and atomic percent. Results shown in Table 1 are normalized to 100% weight percent for ease of calculating ratios of elements. The results reveal that O, Si and Ti are the main elements present within the inspection field of both titanium dioxide treated SBA-16 samples. This suggests that both titanium dioxide doped SBA-16 samples are primarily composed of silica and titanium or silica and titanium oxide. Although titanium seems to make up very little of the elemental composition, its weight percent is above the detection limit of the EDS detector and hence can be counted as significant. We also see that the weight percent ratio of titanium to silicon is consistently about 1 to 14.5, a ratio that supports a titanium oxide coating claim. The consistency of the various EDS spectra shows how consistent the composition is throughout the sample.

TABLE 1
Elemental composition of phase II samples

| | Normalized Weight | | | | Atomic | | | |
|---|---|---|---|---|---|---|---|---|
| | Percent (Wt %) | | | | Percent (At %) | | | |
| Samples | O K | Si K | Ti K | Total | O K | Si K | Ti K | Total |
| Sample A (1) | 55.14 | 42.01 | 2.85 | 100 | 68.91 | 29.90 | 1.19 | 100 |
| Sample A (2) | 55.99 | 41.34 | 2.66 | 100 | 69.61 | 29.28 | 1.11 | 100 |
| Sample A (3) | 60.00 | 37.57 | 2.43 | 100 | 72.98 | 26.03 | 0.99 | 100 |
| Sample B (1) | 57.22 | 39.99 | 2.78 | 100 | 70.70 | 28.15 | 1.15 | 100 |
| Sample B (2) | 53.81 | 43.22 | 2.98 | 100 | 67.75 | 31.00 | 1.25 | 100 |
| Sample B (3) | 58.15 | 39.34 | 2.51 | 100 | 71.44 | 27.53 | 1.03 | 100 |

Transmission Electron Micrograph (TEM) Analysis

FIG. 8 shows the lattice fringes of all titanium dioxide doped SBA-16 samples prepared at this phase. The first batch of titanium dioxide doped sample (SBA16-22 degC-TiO₂-1) is shown in the first column (FIG. 8(a)) while the second batch of titanium dioxide doped sample (SBA16-22 degC-TiO₂-2) is shown in the second column (FIG. 8(b)). Lattice fringes present in the FIGS. 8(a) and 8(b) images suggest that the samples have an ordered porous structure. Regions without these fringes do not necessarily imply that the particle becomes more disordered, as increase in thickness of the particles result in less visible lattice structures. ImageJ based TEM image analysis further verify that the titanium dioxide doped SBA-16 samples possess cubic body-centered Im3m symmetry structure, which is in accordance with SEM characterization results.

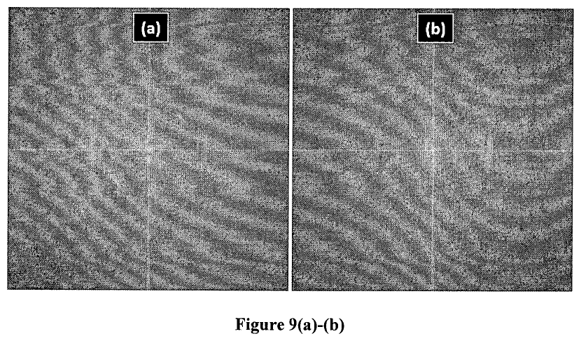

Fast Fourier transforms shown in FIG. 9 are suggestive of a

$$9.16 \frac{nm}{cycle}$$

plane spacing first batch of titanium dioxide doped sample and a 8.15 to

$$8.27 \frac{nm}{cycle}$$

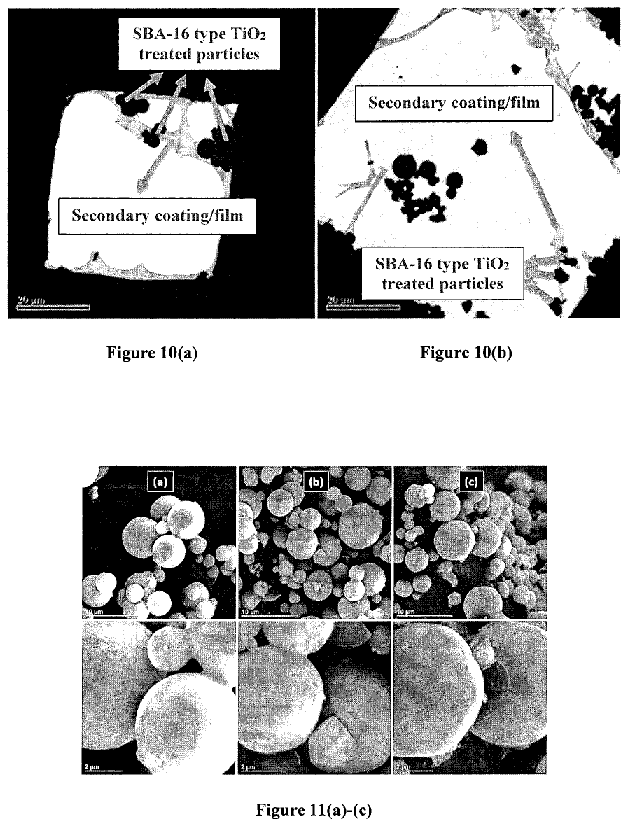

plane spacing for the second batch of titanium dioxide doped sample respectively. Secondary coating/film seen in FIG. 10 are believed to be a product of the titanium dioxide doped SBA-16 particles synthesis and TEM preparation techniques. It is unlikely that the secondary coating/film is a damaged carbon support film as particles wouldn't appear in the micrographs if this was the case.

Proof of Concept Tests (Phase III)

Phase II results verified the viability of the titanium dioxide doping approach. To assess the effectiveness of the process that produced the titanium dioxide doped SBA-16 samples, three new batches of titanium dioxide doped SBA-16 samples were produced. New batches of titanium dioxide doped SBA-16 samples made to be extensively analyzed before applied to water purification speak to the reproducibility of the process, and the effect of changing the amount of titanium dioxide doping. For these new batches of SBA-16 (SBA16-22 degC-POC1) and SBA-16 titanium dioxide doped (SBA16-22 degC-TiO₂—POC1, SBA16-22 degC-TiO₂—POC2 and SBA16-22 degC-TiO₂—POC3) samples, Raman spectroscopy and Nitrogen adsorption-desorption analysis were performed in addition to the testing as done with previous samples. Results of these tests confirmed the readiness of the samples for proof of concept tests whose results have also been included in this section.

Characterization of SBA-16 Titanium Oxide Doped Samples (Phase III)

Scanning Electron Micrograph (SEM) Analysis

FIG. 11 shows SEM images of all titanium dioxide doped SBA-16 samples prepared at this stage. Figure rows indicate the magnification level. The batch of 15 mL titanium dioxide doped sample (SBA16-22 degC-TiO₂—POC1) is shown in the first column (FIG. 11(a)) the batch of 30 mL titanium dioxide doped sample (SBA16-22 degC-TiO₂—POC2) is shown in the second column (FIG. 11(b)), and the batch of 45 mL titanium dioxide doped sample (SBA16-22 degC-TiO₂—POC3) is shown in the third column (FIG. 11(c)). The samples have corresponding morphology, showing individual spherical particles with fractured surfaces and sizes ranging from about 16.39 to 46.28 μm².

Transmission Electron Micrograph (TEM) Analysis

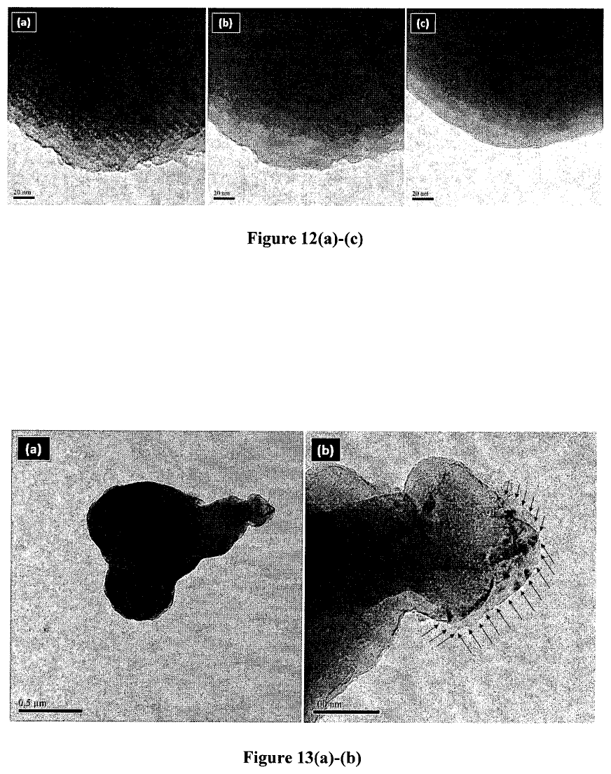

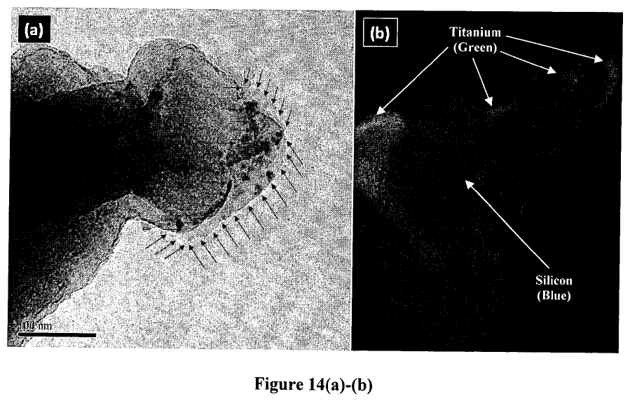

FIG. 12 shows the amorphization of a titanium dioxide doped SBA-16 samples prepared at this stage with beam exposure. FIG. 12(a), FIG. 12(b) and FIG. 12(c) were taken just seconds apart. This quick amorphization combined with increased titanium dioxide doping, makes it difficult to capture lattice fringe images of these samples. Taking this into consideration and the fact that phase II samples have proved the ordered nature of titanium dioxide doped SBA-16 through their lattice fringes, the focus was diverted to exploring the location of titanium dioxide on the samples. FIGS. 13(a) and (b) show one of the samples explored with arrows in FIG. 13(b) indicating possible areas of the titanium dioxide doping. This is confirmed in the EDS mapping image shown in FIGS. 14(a) and (b). The present inventors note the presence of areas of silicon referenced as “(blue)” and titanium referenced as “(green)” in FIG. 14(b). The present inventors also find that the titanium is not randomly dispersed but seems to support the idea of a coating.

Nitrogen Adsorption—Desorption Measurements

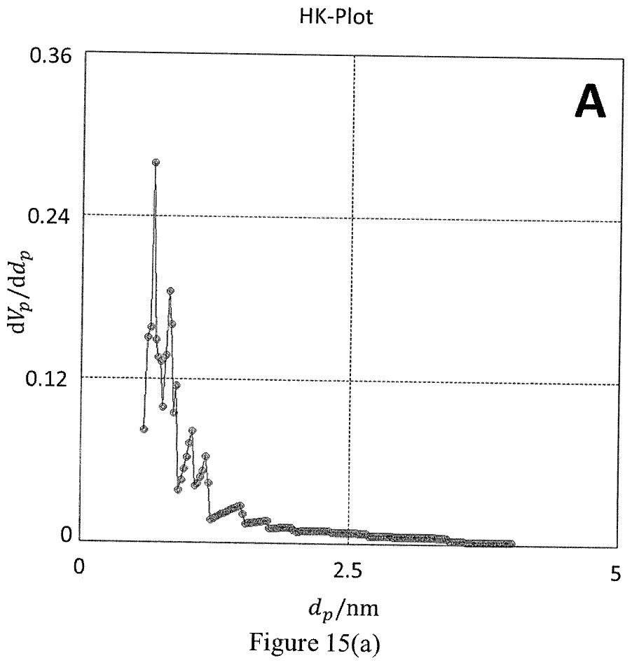

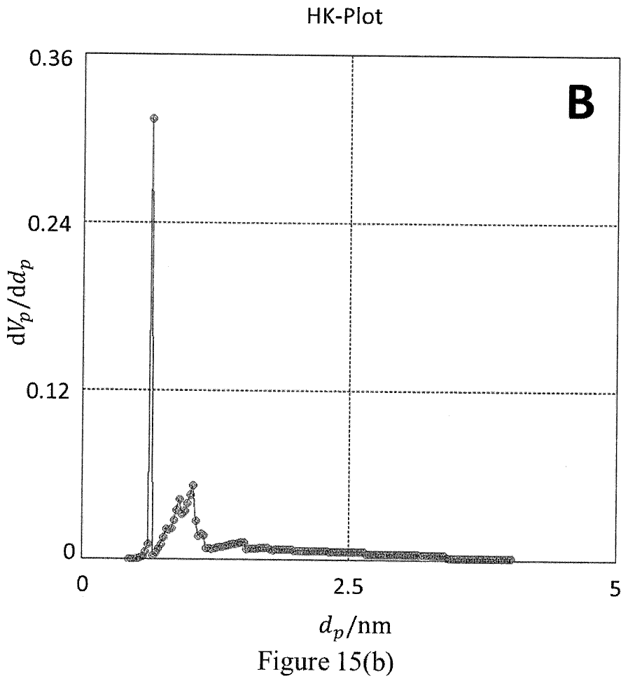

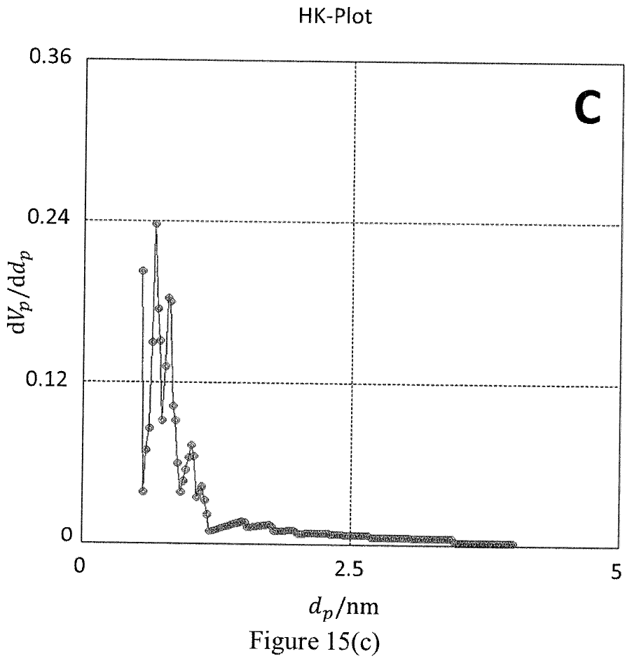

The BET surface area and HK porosity distribution of the undoped SBA-16 and titanium dioxide doped SBA-16 samples were found through physisorption analysis and are shown in Table 2 and FIG. 15, respectively. Titanium dioxide doped SBA-16 samples exhibit relatively large BET surface area, and high pore volume (Table 2). The undoped SBA-16 sample showed the least adsorption potential with a surface area of 188.75 m²/g, total pore volume of 0.1113 cm³/g and mean pore diameter of 2.3589 nm. The 30 mL titanium dioxide doped SBA-16 followed with a BET surface area of 223.48 m²/g, total pore volume of 0.1307 cm³/g and mean pore diameter of 2.3399 nm. While the 45 mL titanium dioxide doped SBA-16 sample showed the most adsorption potential with a BET surface area of 233.08 m²/g, total pore volume of 0.1272 cm³/g and mean pore diameter of 2.1825 nm.

The BET surface area results suggest that increase in the amount of titanium dioxide dopant results in a slight increase in surface area which could possibly lead to an increase in adsorption potential. BET results also show that increase in the amount of titanium dioxide dopant results in a slight decrease in the mean pore diameter. Whether or not sacrificing pore diameter for titanium doping will improve the material's effectiveness in water purification applications will be explored in the photoactivity sub section. A related concern was that the titanium dioxide doping would result in considerable pore blocking. While the reduction in pore diameter with increase in titanium dioxide doping might suggest some amount of pore blocking/pore coating, this amount of pore blocking/pore coating is not significant enough to be of concern.

Errors are in the range of 5-10% of the mean value. The BELSORP-max machine has an inherent error of approximately ±5%. Nitrogen-sorption data shown in FIG. 10 gives type IV curves for both undoped SBA-16 and titanium dioxide doped SBA-16 samples. A relatively small H2-type hysteresis loop characteristic of materials with cage-like uniform mesopores interconnected by relatively narrow apertures can be observed at P/Po 0.4-0.6 in the undoped SBA-16 sample and at P/Po 0.4-0.6 in the 15 mL doped SBA-16 sample (FIG. 11). The hysteresis loop decreases gradually upon further increasing the titanium content, suggesting that its mesostructure collapsed in the high Ti-content composite.

TABLE 2
Total pore volume and BET surface area of phase III samples

| | Total Pore | BET Surface |
|---|---|---|
| Samples | Volume (cm³/g) | Area (m²/g) |
| SBA16-22degC-POC1 | 0.1113 | 188.75 ± |
| SBA16-22degC-TiO₂-POC2 | 0.1307 | 223.48 ± |
| SBA16-22degC-TiO₂-POC3 | 0.1272 | 233.08 ± |

The HK pore size distribution results calculated from desorption curves demonstrate that the peak pore diameter for the undoped, 30 mL doped, and 45 mL doped samples are between 0.66 nm, 0.64 nm and 0.66 nm respectively. The HK pore size distribution also confirms that the SBA-16 is microporous not mesoporous as the bulk of the pores lie within 0.5 nm to 1.5 nm, a range classified by the IUPAC as microporous. There is little variation between the results of the three samples. 50% of pores are below 1 nm, while 95% of the pores are below 2.5 nm. The steady state value of pore volume (cc/g) is shown in Table 2, while the complete distributions are presented below in FIG. 9. Cumulative porosity distribution represents the amount of nitrogen absorbed in pores of increasing magnitude, during physiosorption analysis.

Raman Spectroscopy

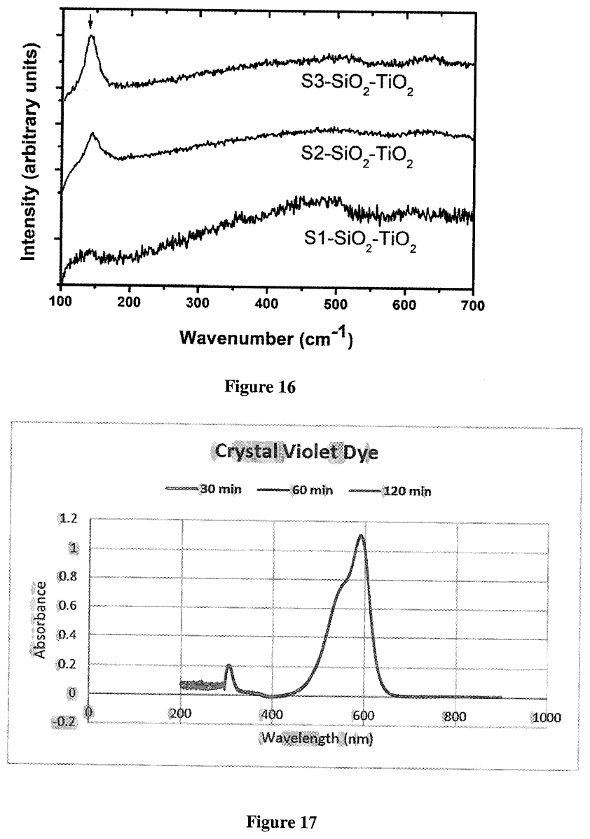

Raman spectra shown in FIG. 16 establishes the nature of the titanium dioxide present in the titanium dioxide doped SBA-16 samples. The peaks marked by the arrow correspond to the Anatase phase of crystalline titanium dioxide. This information is important because it establishes that the doping really is titanium dioxide and not titanium or some other oxide of titanium. The figure also establishes a relationship with titanium dioxide doping amount, as it shows that the sample peak and hence the amount of Anatase form of titanium dioxide, becomes more pronounced as titanium dioxide doping increases. As the Anatase form of titanium dioxide is the form of titanium dioxide that absorbs UV light, the samples are expected to strongly support photocatalysis.

FIG. 16 also shows little sign of absorbance at 144 cm⁻¹ for the 15 mL titanium dioxide doped sample, but significant absorbance at 144 cm⁻¹ for the 30 mL titanium dioxide doped sample and intense absorbance at 144 cm⁻¹ for the 45 mL titanium dioxide doped sample suggesting that the bulk Titania (anatase phase) became more pronounced with increased titanium dioxide doping.

Photocatalytic activity of Titanium Oxide Doped SBA-16 Samples

The optical absorption spectrum of crystal violet is characterized by three bands in the UV region located at 208 nm, 249 nm, and 303 nm, and one band in the visible region located at 591 nm. Crystal violet degradation was monitored and accessed by the absorbance changes in the visible region band during photodegradation of the crystal violet in aqueous solution. The absorption spectrum of crystal violet shown in FIG. 17 suggests that with increasing irradiation time, the absorbance peak at 590 nm decreases with an overall shift in the absorption wavelength from 590 nm to 589.5 nm. This absorption peak decrease and leftward shift in the absorption peak's wavelength are indicators of crystal violet decomposition. Meaning the absorption spectrum shown in FIG. 17 shows the ability of UV irradiation to decompose and degrade organic material (in this case crystal violet).

Table 3 shows the corresponding wavelength value of the absorption peak for each crystal violet solution irradiation time.

TABLE 3
Irradiation time and wavelength values of crystal violet spectral changes

| Irradiation time | Wavelength (nm) |
|---|---|
| 0 | 590 |
| 10 | 590.5 |
| 30 | 590 |
| 60 | 590 |
| 120 | 589.5 |

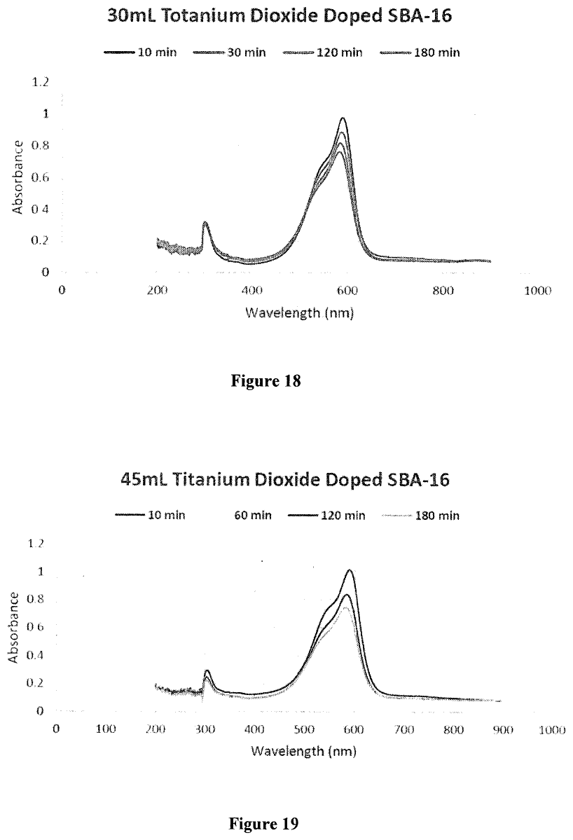

Having observed the effect of UV-B irradiation on crystal violet, the effect of titanium dioxide doped SBA-16 material can be observed, and a comparison made. FIGS. 18 and 19 show the absorption spectrum of crystal violet with the incorporation of 30 mL (S2-SiO₂—TiO₂) and 45 mL (S3-SiO₂—TiO₂) titanium dioxide doped SBA-16 samples respectively. Like the FIG. 17 plot, the 30 mL and 45 mL titanium dioxide doped SBA16 incorporated plots show an overall decrease in the absorption peak and a leftward shift in the absorption peak's wavelength from 590.5 nm to 583 nm and 591 nm to 582 nm respectively. However, the overall change in the absorption peak and leftward shift are greater when the titanium dioxide doped samples are incorporated than with simple UV-B irradiation. This suggests an improvement in the effectiveness of photodegrading crystal violet with the incorporation of titanium dioxide doped SBA-16 to the irradiation process.

Leftward shift values for the titanium dioxide doped sample incorporation are comparable to previous research on photodegradation of crystal violet using titanium dioxide (Chen, C., Fan, H., Jang, C., Jan, J., Lin, H., & Lu, C. (2007). Photooxidative n-de-methylation of crystal violet dye in aqueous nano-TiO2 dispersions under visible light irradiation. Journal of Photochemistry and Photobiology. A, Chemistry,184(1), 147; Priya, S., Robichaud, J., Methot, M., Balaji, S., Ehrman, J., Su, B., & Djaoued, Y. (2009). Transformation of microporous titanium glycolate nanorods into mesoporous anatase titania nanorods by hot water treatment. Journal of Materials Science, 44(24), 6470-6483).

Regards,) in which a leftward shift of the UV-Vis absorption peak from 588.3 to 543.2 nm and 591.5 to 563 nm were seen respectively. These shifts are significantly larger than what are shown in this research's proof of concept test because of the stronger UV-C irradiation used in comparison to this research's UV-B irradiation. Leftward shifts have been attributed to consecutive N-demethylation reactions, corresponding to removal of methyl groups. Table 4 shows the corresponding wavelength value of the absorption peak for each irradiation time of the 30 mL (S2-SiO₂—TiO₂) and 45 mL (S3-SiO₂—TiO₂) titanium dioxide doped SBA-16 samples.

TABLE 4
Irradiation time and wavelength values of crystal violet spectral changes
under the action of the 30 mL and 45 mL TiO2 doped SBA-16 samples

| Irradiation | S2-SiO₂-TiO₂ | S3 -SiO₂-TiO₂ |
|---|---|---|
| time | Wavelength (nm) | Wavelength (nm) |
| 0 | 590.5 | 591 |
| 10 | 589.5 | 590.5 |
| 30 | 587.5 | 589.5 |
| 60 | 586.5 | 586.5 |
| 120 | 585 | 584.5 |
| 180 | 585 | 582 |

The present inventors find that of the titanium dioxide doped samples tested, the 45 mL titanium dioxide doped sample shows faster crystal violet degradation. As the photodegradation of crystal violet takes place on the surface of titanium dioxide particles, it is believed that the increase of the titanium dioxide loading increases the surface coverage of titanium dioxide on the undoped SBA-16, which leads to the enhancement of the rate of photodegradation of crystal violet. While a comparison with undoped SBA-16 wasn't carried out, it is expected that the photodegradation potential of titanium dioxide doped SBA-16 is significantly greater than that of undoped SBA-16.

Titanium dioxide Doped SBA-16 Deployment Method

Membrane Filtration

Membranes are physical interfaces that serve as selective barriers to the transport of matter between two separate phases. Essentially, only compounds smaller than the membrane openings are allowed through. There are four distinguishable types of pressure-driven membrane processes: microfiltration, ultrafiltration, nanofiltration, and reverse osmosis. Microfiltration membranes have relatively large pore sizes and can reject large particulates and microorganisms. Ultrafiltration membranes have smaller pores than microfiltration membranes and can reject bacteria and soluble macromolecules. Reverse osmosis membranes have the smallest pore sizes and can reject particulates and numerous low molecular weight species such as salt ions and small organic molecules while nanofiltration membranes are thought of as “loose” reverse osmosis membranes exhibiting performance parameters between ultrafiltration and reverse osmosis membranes.

Membrane filtration can be carried out through dead-end filtration or cross-flow filtration. In dead end filtration, the feed water flows perpendicular to the membrane surface, meaning all solids will amass onto the membrane surface during filtration. The accumulation of solids in dead-end filtration often results in a lower flux compared to cross-flow filtration. In cross-flow filtration, the feed water is parallel to the membrane surface. The flow velocity parallel to the surface of the membrane generates a shear force that reduces the growth of a filter cake. Since most solids pass with the retentate instead of collecting on the membrane surface, the system can function at higher flux compared to dead-end filtration. Membrane fabrication configurations fall into four different groups: (i) tubular, (ii) flat sheet (plate and frame), (iii) hollow fiber, and (iv) spiral wound. The tubular configuration is preferred for ceramic membranes that have low packing densities. The flat sheet (plate and frame) membrane configuration is commonly used for laboratory separations. Hollow fiber and spiral wound membrane configurations are often used for nanofiltration and reverse osmosis membranes.

Although most membranes are made from synthetic organic polymers, which can be hydrophobic or hydrophilic, membranes can be prepared from inorganic materials, like metals and ceramics. Inorganic membranes offer high stability at high temperatures (over 100° C.) and at extreme pH, but are brittle due to their crystal structure. Ceramic materials most times are composite materials consisting of one or many different ceramic materials. They usually have a macroporous support, followed by a few layers of microporous top layers. Commonly used materials for ceramic membranes include alumina, titanium dioxide, zirconium dioxide, silicon dioxide, or a mixture of these materials.

A major problem of membranes is membrane fouling. This process can occur on the surface of the membrane and/or within the pores of the membrane and usually leads to reduction in flux. Types of fouling include biofouling, organic, colloidal, and scaling. Biofouling stems from microorganism contamination of the feed water and produces a biofilm on the surface of the membranes. Scaling arises from deposition and precipitation of salts onto the membrane. Colloidal fouling stems from particles, such as silica and clay, collecting on the surface of the membrane while organic fouling stems from substances such as hydrocarbons, dyes, and pesticides coating the surface and/or plugging pores of the membrane. The combination of titanium dioxide doped SBA-16 with membrane processes presents a viable deployment method for titanium dioxide doped SBA-16 in water purification. By incorporating titanium dioxide doped SBA-16 to the membrane system, dissolved low-molecular weight organic substances can be adsorbed and degraded simultaneously, thereby significantly reducing membrane fouling.

We claim:

1. A process for producing a transitional metal oxide-coated mesoporous material, comprising:
dispersing a mesoporous material in a solvent to form a mesoporous material dispersion;
adding a transition metal oxide solution to the dispersion to form a mixture; and
collecting the resulting transitional metal oxide coated mesoporous material.

2. The process of claim 1, wherein the mesoporous material comprises microspheres.

3. The process of claim 2, wherein the transitional metal oxide is TiO₂.

4. The process of claim 1, wherein the transition metal oxide solution comprises transitional metal oxide nanocrystals.

5. The process of claim 4, wherein the mesoporous material is silica based.

6. The process of claim 4, wherein the TiO₂ comprises TiO₂ nanocrystals.

7. The process of claim 3, wherein the TiO₂ is prepared from Ti(iPO)₄ as the TiO₂ source material.

8. The process of claim 5, wherein the mesoporous material has been produced using a sol-gel process wherein self-assembly of silica-pluronic molecules leading to molecular periodic arrangement in the sol-gel process is carried out at a low temperature.

9. The process of claim 8, wherein the low temperature is about 22° C.

10. The process of claim 8, wherein the low temperature is between about 1° C. and about 30° C.

11. The process of claim 8, wherein the low temperature is room temperature.

12. The process of claim 4, wherein the mesoporous material is SBA-16.

13. The process of claim 4, wherein the mesoporous material is selected from the group comprising MCM-41, MCM-45, MCM-48, and SBA-15.

14. The process of claim 12, wherein the titanium dioxide nanocrystals are made from Ti(iPO)₄ as the titanium dioxide source material.

15. A transitional metal oxide-coated mesoporous material produced according to the process of claim 4.

16. A metal oxide-coated mesoporous material comprising mesoporous silica coated with titanium dioxide nanocrystals.

17. The metal oxide-coated mesoporous material of claim 16, wherein the mesoporous silica comprise microspheres.

18. The metal oxide-coated mesoporous material of claim 16, wherein the mesoporous silica is SBA-16.

19. Use of the metal oxide-coated mesoporous material of claim 16 for nanofiltration.
